(19) United States
(12) Patent Application Publication
(10) Pub. No.: US 2026/0126151 A1
(43) Pub. Date: May 7, 2026

(54) FOLDING SECTION FOR THE BASE

(71) Applicant: Brian Goldwitz, WATERBURY, CT (US)

(72) Inventor: Brian Goldwitz, WATERBURY, CT (US)

(21) Appl. No.: 19/376,949

(22) Filed: Nov. 1, 2025

Related U.S. Application Data
(60) Provisional application No. 63/715,511, filed on Nov. 1, 2024.

(51) Int. Cl. F16M 13/02; B60R 9/06

(52) U.S. Cl. CPC F16M 13/022; B60R 9/065

(57) ABSTRACT

The current invention is a new design for a folding section for the base of a foldable trunk. The folding section folds down on the floor allowing the foldable trunk to sit flat. The current device has a hinge design that allows for the hinges to easily be attached to the bed of the vehicle.

### RELATED APPLICATIONS

This application claims the priority date of Provisional Application 63/715,511 filed on Nov. 1, 2024.

### TECHNICAL FIELD

The technology discussed below relates a bracket for a base of a panel to a vehicle such as a wrangler or jeep

### BACKGROUND

People need with SUV and jeeps sometimes need a trunk to store and transport goods while driving their SUV (“Sports Utility Vehicle”) such as a Bronco®. The current art does not allow a foldable easy to install installable trunks.

There exists a great need for a trunk for SUVs that is foldable when there is no longer need for a trunk. This will allow the user to fold the trunk when a larger space in the bed is needed.

There is still room for improvement in the art.

### SUMMARY

The current invention is a new design for a folding bracket for the base of a foldable trunk. The folding section folds down on the floor allowing the foldable trunk to sit flat. The current device has a double hinge design that allows for the bracket to easily be attached to the bed of the vehicle.

These are improvements over the current art.

### DETAILED DESCRPTION OF THE FIGURES

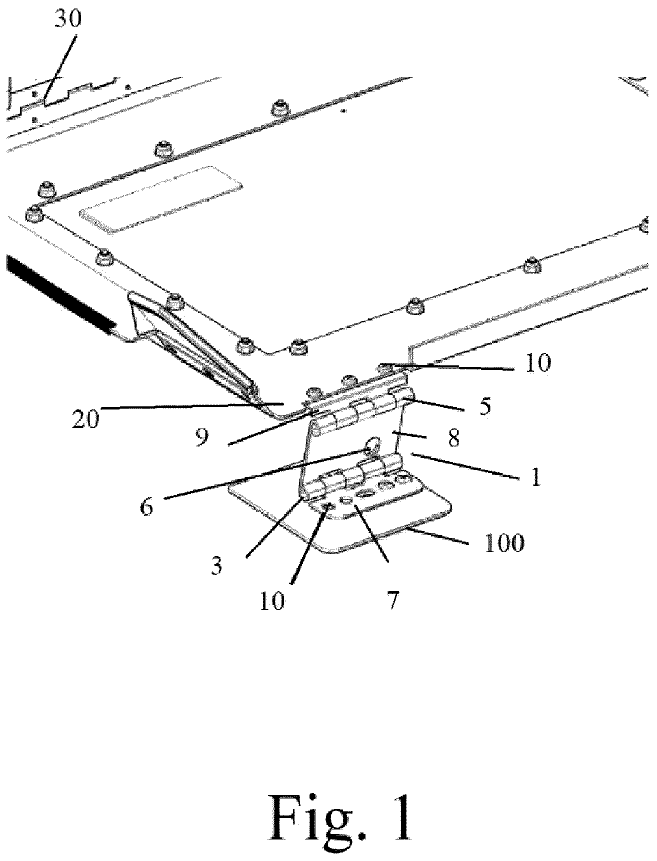

FIG. 1 is a display of a bracket in an extended-up view.

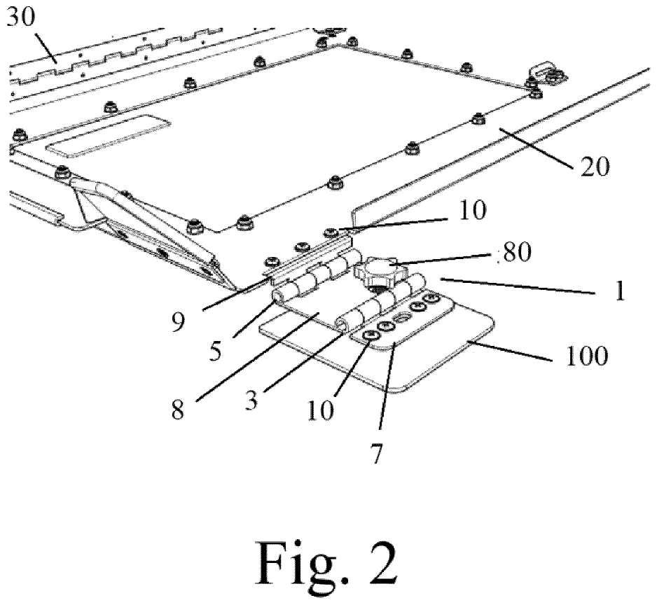

FIG. 2 shows a bracket with the bracket securing screw in a flat position.

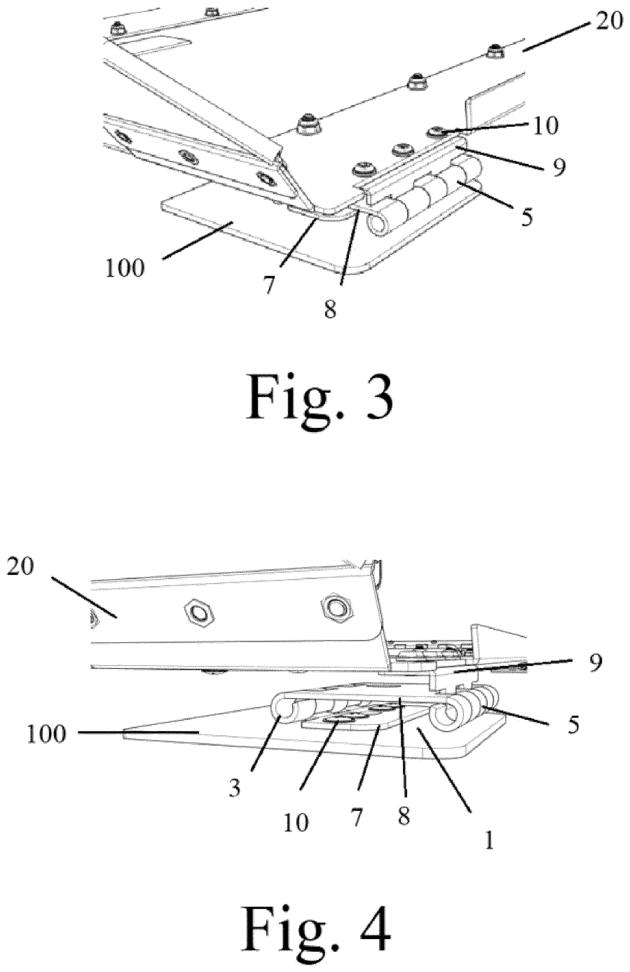

FIG. 3 shows a close-up view of the bracekt in a closed position.

FIG. 4 shows a side view of the hinge attached the trunk configuration.

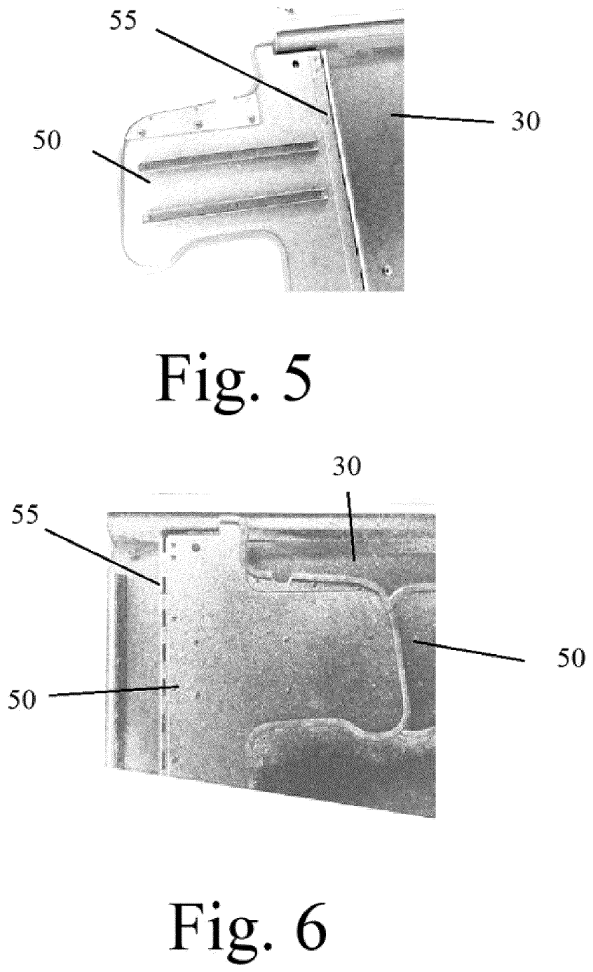

FIG. 5 shows a side panel extended out.

FIG. 6 shows a side panel fold in a storage position.

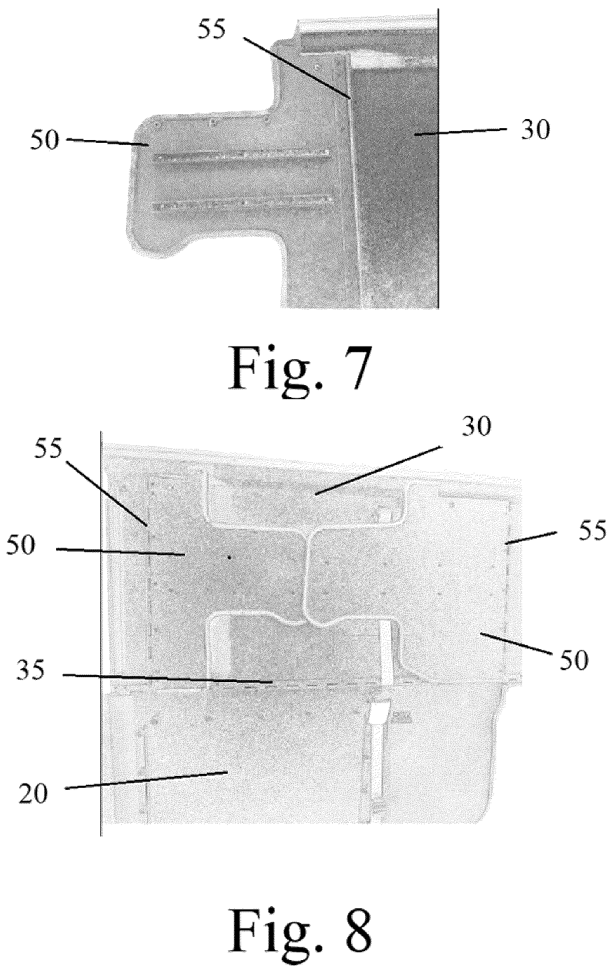

FIG. 7 shows a side panel in an open position.

FIG. 8 shows the panels in a folded position.

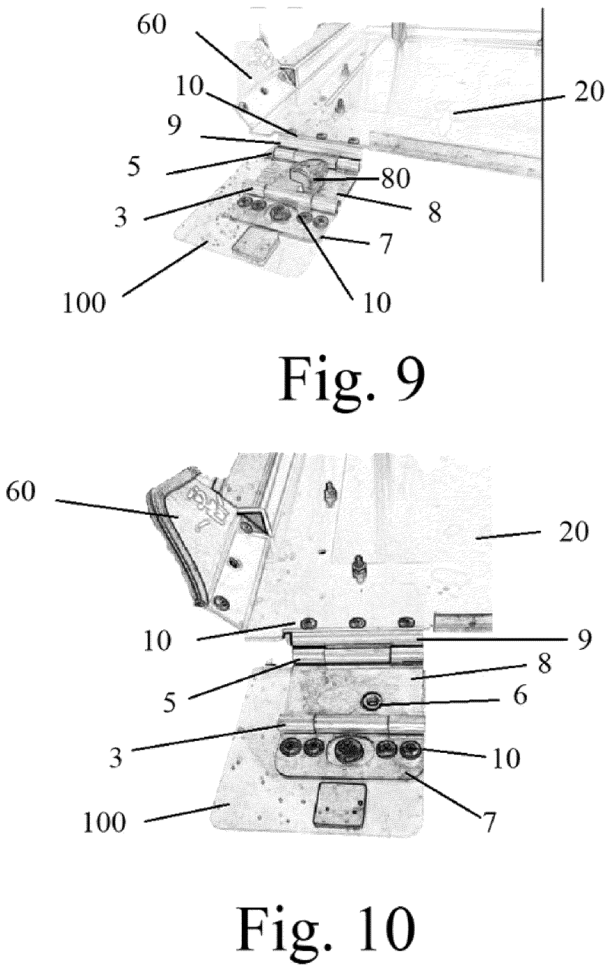

FIG. 9 shows a bracket attached to the main panel.

FIG. 10 shows a bracket attached the main panel with the side panel extended out.

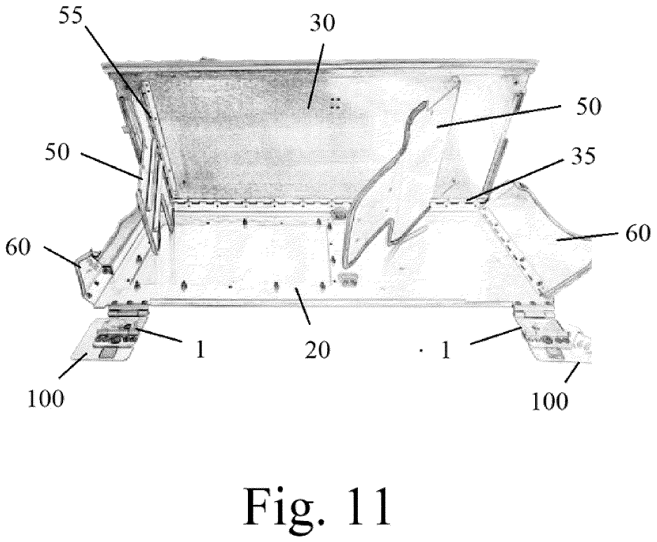

FIG. 11 shows the panels being unfolded.

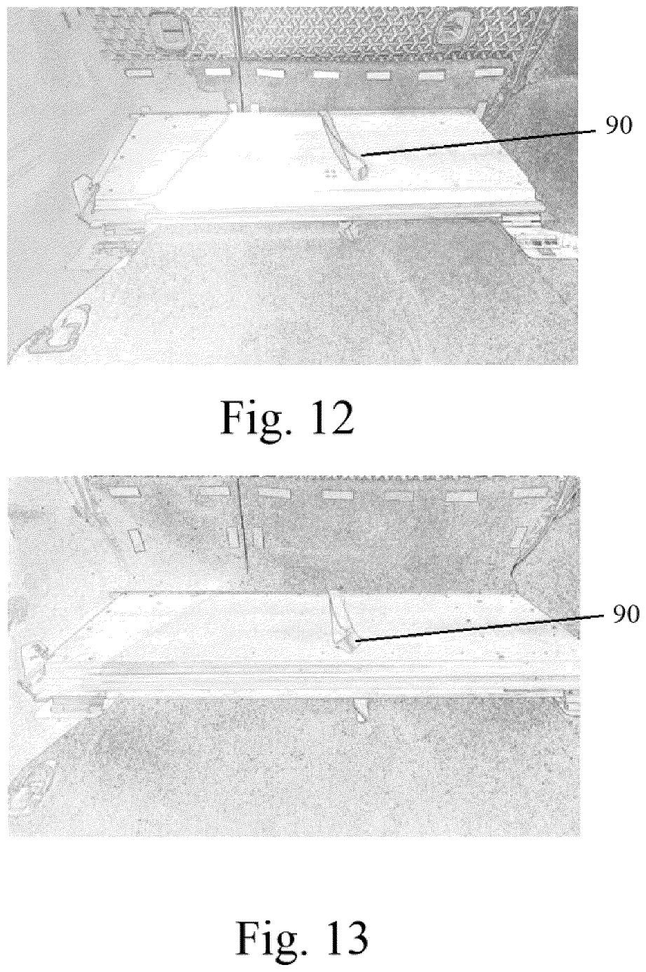

FIG. 12 shows the panels folded flat in the bed with a pull cord.

FIG. 13 shows another view of the panels folded flat in the bed.

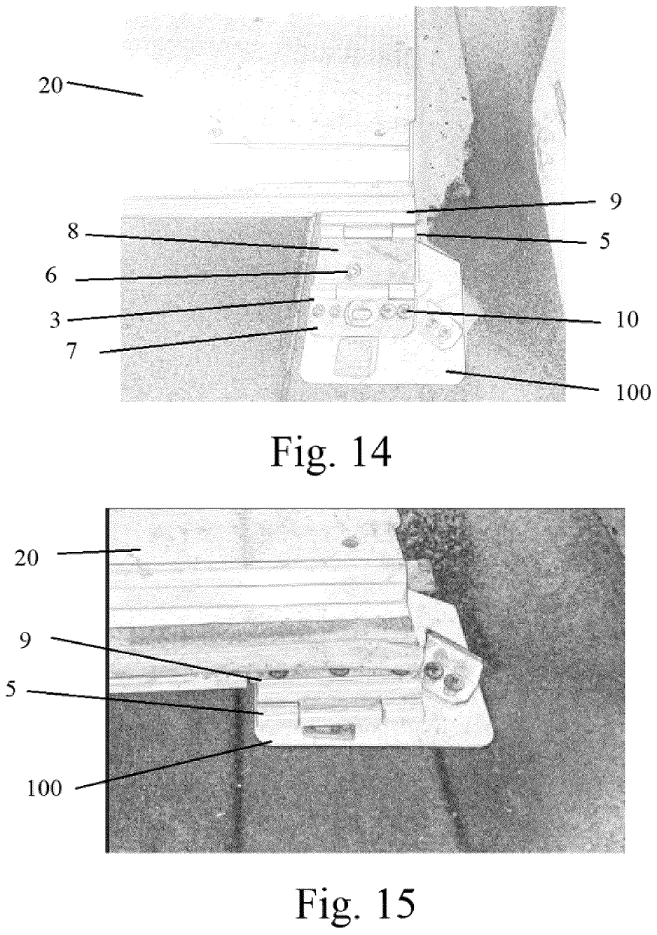

FIG. 14 shows the main panel in the trunk position attached to a bracket

FIG. 15 shows the main panel in the folded position attached to a bracket.

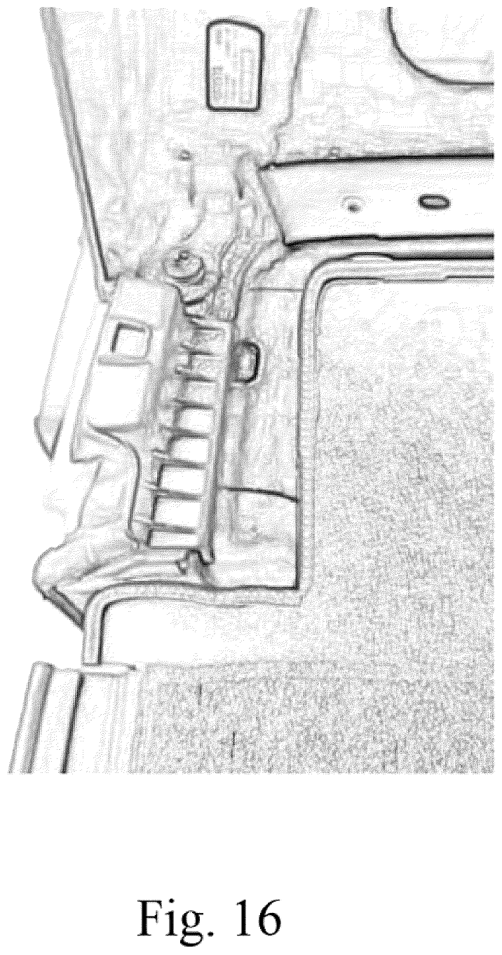

FIG. 16 shows a connection with the panels.

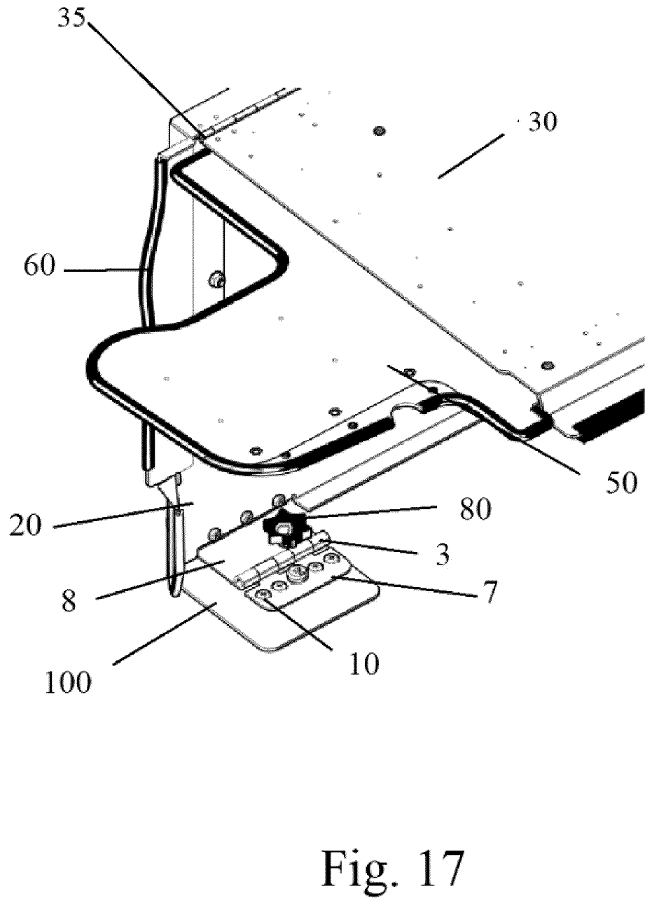

FIG. 17 shows the main panel connected to the bracket with the mail panel in the trunk position attached to a top panel with a side panel extended.

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

FIGS. 1 through 17 shows the current invention is a new design for bracket for a trunk hinging system and folding system for the base of a folding trunk or similar device.

FIG. 1 shows an embodiment of a unique bracket 1 and hinging system that can attach to the bed of a vehicle designed to work both when the panels are extended or folded flat on the bed of the vehicle. The bracket 1 is attached to a base 100 on the floor or bed of a vehicle. The bracket 1 consists of a front plate 7 attached to a middle plate 8 by a front hinge 3 with the middle plane 8 attached to a back plate 9 by a back hinge 5. This double hinge combination adds functional to the bracket 1. The front plate 7 is attached to the bed or floor of a vehicle through a base 100 using an attachment means 10 such bolts or pins. The back plate 9 is attached to a panel 20 using an attachment means such as bolts or pins 10. FIG. 1 shows the bracket 1 is it's extended position. The front plate 7, middle plate 8 and back plate 9 are flat rectangular plates with the front plate 7 and back plate 9 having rounded edges on one side and connected to a hinge on the other opposite side as shown in the figures.

In the preferred embodiment, as shown in FIG. 11, there are two brackets 1 one at each end of the main panel 20 to stabilize the main panel 20 and connect it to the vehicle bed. More than two brackets 1 can be used.

The bracket 1 uses pins or bolts 10 or other type of attachment means to connect to the main panel 20 and the base 100.

The middle plate 8 has a reception threaded hole 6 in the center of the middle plate 8.

FIG. 2 shows a bracket 1 the flat position which is used to secure the bracket 1 and thereby secure the panels such as the main panel 20. The middle plate 8 is secured by a threaded thumb screw 80 which secures the middle plate 8 to the base by screwing into the base 100 by turning through the threaded hole 6 in the middle plate 8. This also locks the panels.

FIGS. 3 and 4 shows a close-up view of the hinge in a closed position in a forward flat position in a flat configuration.

FIG. 5 shows a side panel 50 extended out from the top panel 30. The side panel 50 is attached to the top panel 30 by side panel hinges 55. FIG. 6 shows two side panels 50 folded against the top panel 30 in a storage position while FIG. 7 shows a side panel 50 in an open position.

FIG. 8 shows the panels in a folded position with the side panels 50 folded back against the top panel 30 with the top panel 30 connected to the main panel 20 through a top panel hinge 35.

FIGS. 9 and 10 shows a bracket 1 attached to the main panel 20. It also shows an edge panel 60 that is attached to the side of the main panel 10 by an edge hinge 65. FIG. 10 show the edge panel 60 extended out from the main panel 20.

The panels fold out to a trunk configuration for vehicles that do not have a trunk.

FIG. 11 shows the trunk being unfolded with the two brackets 1 in a trunk position. The main panel 20 being secured by the brackets 1. The top panel 30 being lifted to a top position parallel with the bed with the side panels 50 being extended out from the top panel 30 and the edge panels 60 being extended out from the main panel 20.

In the preferred embodiment, the main panel 20 and the top panel 30 are rectangular in shape. The edge panels 60 can be rectangular in shape or have an irregular shape depending on the need and vehicle. The side panels 50 can be rectangular in shape but in the displayed figures are wider at the connection with the top panel 30 which rounds out to thinner extension in almost a “T” shape. The inner side of the side panel 50 has two parallel ridges in the preferred embodiment for additional support. The side panels 50 extend out and support the top panel 30. FIGS. 12 and 13 shows the panels folded flat in a vehicle bed with a pull cord 90. The pull cord 90 help to pull out the panels to form the trunk.

FIG. 14 shows the main panel 20 and a bracket 1 in the trunk position. FIG. 15 shows the main panel 20 in the folded position attached to a bracket 1. FIG. 16 shows a connection between the panels.

FIG. 17 shows the main panel 20 connected to the bracket in the locked position with the thumb turn screw 80 with the mail panel 20 in the trunk position attached to a top panel 30 with a side panel 50 extended.

The bracket 1 folds forward on its two hinges for the flat storage configuration of the trunk and backward with the licking Thumb screw 80 in the trunk position as shown in the figures. This uniqueness of the double hinges used in this fashion improves its functionality when used with a foldable trunk or other similar device.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

I claim:

1. A bracket comprising:
a front plate connected to a front hinge which is connected to a middle plate which is attached to a back hinge which is attached to a back plate.

2. A bracket according to claim 1 comprising:
where the front plate, middle plate and back plate are flat rectangular plates.

3. A bracket according to claim 1 comprising:
where the front plate and back plate have rounded edges on one side and connected to a hinge on the other opposite side.

4. A bracket according to claim 1 comprising:
where the front plate is connected to an automobile bed.

5. A bracket according to claim 1 comprising:
where the front plate is connected to a base.

6. A bracket according to claim 1 comprising:
where the back plate is connected to a panel.

7. A bracket according to claim 1 comprising:
where the middle plate has a threaded hole.

8. A bracket according to claim 1 comprising:
having a threaded thumb screw which secures the middle plate by screwing through the threaded hole 6 in the middle plate.

9. A bracket comprising:
a front plate connected to a front hinge which is connected to a middle plate which is attached to a back hinge which is attached to a back plate, where the front plate, middle plate and back plate are flat rectangular plates, where the front plate and back plate have rounded edges on one side and connected to a hinge on the other opposite side, and where the middle plate has a threaded hole.

10. A bracket according to claim 9 comprising:
where the front plate is connected to an automobile bed.

11. A bracket according to claim 9 comprising:
where the front plate is connected to a base.

12. A bracket according to claim 9 comprising:
having a threaded thumb screw which secures the middle plate by screwing through the threaded hole in the middle plate.

13. A bracket comprising:
a front plate connected to a front hinge which is connected to a middle plate which is attached to a back hinge which is attached to a back plate, where the front plate, middle plate and back plate are flat rectangular plates, where the front plate and back plate have rounded edges on one side and connected to a hinge on the other opposite side, where the middle plate has a threaded hole where the back plate is connected to a main panel where the main panel is attached to a top panel where the panels can be folded flat and unfolded to form a trunk.

14. A bracket according to claim 13 comprising:
where the panels are rectangular in shape.

15. A bracket according to claim 13 comprising:
where the front plate is connected to a base.

16. A bracket according to claim 13 comprising:
having a pull cord attached to the top panel.

17. A bracket according to claim 13 comprising:
having side panels attached to the top panel.

18. A bracket according to claim 13 comprising:
having edge panels attached to the main panel.

19. A bracket according to claim 13 comprising:
where the middle plate has a threaded hole.

20. A bracket according to claim 13 comprising:
having a threaded thumb screw which secures the middle plate by screwing through the threaded hole 6 in the middle plate.
